(19) United States
(12) Patent Application Publication
(10) Pub. No.: US 2024/0006590 A1
(43) Pub. Date: Jan. 4, 2024

(54) FINE BLANKED BATTERY ELECTRODES

(71) Applicant: Apple Inc., Cupertino, CA (US)

(72) Inventors: Daeshin Lee, San Jose, CA (US); Rajesh Kandibanda, Los Gatos, CA (US); Joshua M. Chien, Menlo Park, CA (US); Mark E. Wilcox, Morgan Hill, CA (US)

(21) Appl. No.: 17/959,125

(22) Filed: Oct. 3, 2022

Related U.S. Application Data
(60) Provisional application No. 63/357,893, filed on Jul. 1, 2022.

(51) Int. Cl. H01M 4/36; H01M 4/583; H01M 4/525

(52) U.S. Cl. CPC H01M 4/366; H01M 4/583; H01M 4/525; H01M 2004/021

(57) ABSTRACT

A battery includes a separator having a first side and a second side opposing the first side. The battery also includes an anode having an anode face that faces the first side of the separator, where the anode face includes an anode face surface area. The battery also includes a cathode having a cathode face that faces the second side of the separator, where the cathode face includes a cathode face surface area. A surface area ratio between the anode face surface area and the cathode face surface area is between 1.030 and 1.038.

### CROSS-REFERENCE TO RELATED APPLICATIONS

This application claims priority to U.S. Provisional Application No. 63/357,893, filed Jul. 1, 2022, entitled “FINE BLANKED BATTERY ELECTRODES,” the disclosure of which is incorporated by reference in its entirety for all purposes.

### BACKGROUND

The present disclosure relates generally to battery electrodes. More specifically, the present disclosure relates to increasing a volumetric energy density of a battery employing the battery electrodes.

A battery may be formed by electrodes, one or more separators, electrolyte, a housing, terminals, and other possible componentry. The battery may be employed as a source of power for an electronic device. In certain batteries, such as secondary (e.g., rechargeable) batteries having stacked electrodes, a first electrode (e.g., an anode) may be larger than a second electrode (e.g., a cathode). Indeed, a sufficient size difference between the anode and the cathode, and proper placement of the anode relative to the cathode, may ensure that the battery functions and operates properly.

However, due at least in part to limitations in traditional manufacturing systems and processes for producing traditional batteries, a size difference between the anode and the cathode may be relatively large to account for relatively large deviations from nominal or design sizes of the anode and the cathode. For example, the nominal or design size of the cathode may be relatively small with respect to the nominal or design size of the anode, such that a sufficient size difference between the anode and the cathode will exist even if a size of the anode deviates from the nominal or design size and/or a size of the cathode deviates from the nominal or design size. Unfortunately, the relatively large size difference between the anode and the cathode may contribute to wasted space within the battery and reduce a volumetric energy density thereof. For at least these reasons, among others, improved batteries and battery manufacturing are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery includes a separator having a first side and a second side opposing the first side. The battery also includes an anode having an anode face that faces the first side of the separator, where the anode face includes an anode face surface area. The battery also includes a cathode having a cathode face that faces the second side of the separator, where the cathode face includes a cathode face surface area. A surface area ratio between the anode face surface area and the cathode face surface area is between 1.030 and 1.038.

In another embodiment, a battery includes an anode having an anode face with an anode width dimension and an anode height dimension. The battery also includes a cathode having a cathode face with a cathode width dimension and a cathode height dimension. The battery also includes a width ratio between the anode width dimension and the cathode width dimension within a first range of 1.006 to 1.009. The battery also includes a height ratio between the anode height dimension and the cathode height dimension within a second range of 1.022 to 1.024.

In yet another embodiment, a battery assembly includes an anode having an anode face, where the anode face includes an anode face surface area. The battery also includes a cathode having a cathode face, where the cathode face includes a cathode face surface area. A surface area ratio between the anode face surface area and the cathode face surface area is between 1.030 and 1.038. The battery also includes a portion of the anode forming an anode/cathode overhang that extends beyond a perimeter of the cathode.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is an exploded perspective view of a battery employed to power the electronic device of FIG. 1, according to embodiments of the present disclosure;

FIG. 3 is an overhead view of a layered material employed to produce one or more battery electrodes for the battery of FIG. 2, according to embodiments of the present disclosure;

FIG. 4 is a side cross-sectional view of the layered material of FIG. 3, according to embodiments of the present disclosure;

FIG. 5 is an overhead view of the layered material of FIG. 3, in which a first electrode (e.g., an anode) is cut from the layered material via a fine blanking technique, according to embodiments of the present disclosure;

FIG. 6 is an overhead view of the layered material of FIG. 3, in which a second electrode (e.g., cathode) is cut from the layered material via a fine blanking technique, according to embodiments of the present disclosure;

FIG. 7 is a side cross-sectional view of a portion of the battery of FIG. 2 including the first electrode (e.g., the anode) of FIG. 5, the second electrode (e.g., the cathode) of FIG. 6, and a separator, according to embodiments of the present disclosure;

FIG. 8 is a perspective view of a stacked arrangement including the first electrode (e.g., the anode) of FIG. 5, the second electrode (e.g., the cathode) of FIG. 6, and an anode/cathode overhang defined by the stacked arrangement, according to embodiments of the present disclosure;

FIG. 9 is an overhead view of a cathode and corresponding dimensions employed in the battery of FIG. 2, according to embodiments of the present disclosure;

FIG. 10 is an overhead view of an anode and corresponding dimensions employed in the battery of FIG. 2, according to embodiments of the present disclosure;

FIG. 11 is a schematic side view of a fine blanking system that produces or creates electrodes for the battery of FIG. 2, according to embodiments of the present disclosure;

FIG. 12 is a schematic side view of a portion of the fine blanking system of FIG. 11 in which a punch is disengaged from a layered material, according to embodiments of the present disclosure;

FIG. 13 is a schematic side view of a portion of the fine blanking system of FIG. 11 in which a punch is engaged with a layered material and in the process of coordinating with a suction pad to cut an electrode from the layered material, according to embodiments of the present disclosure;

FIG. 14 is a schematic side view of a portion of the fine blanking system of FIG. 11 in which an electrode is cut from the layered material, according to embodiments of the present disclosure; and

FIG. 15 is a schematic side view of another fine blanking system configured to generate electrodes for the battery of FIG. 2, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure relates generally to fine blanking of battery electrodes in a battery. More specifically, the present disclosure relates to battery electrodes produced via a fine blanking technique that generates battery electrodes having more consistent and/or precise sizes, which enables an improvement in volumetric energy density of the battery relative to traditional embodiments.

In accordance with the present disclosure, a battery (e.g., a secondary or rechargeable battery, such as a lithium-ion battery) may include electrodes, electrode tabs extending from bodies of the electrodes, electrolyte, one or more separators configured to separate the electrodes, a housing, battery terminal tabs, and other possible componentry. For example, the housing may define a housing interior configured to receive the electrodes (e.g., at least one anode and at least one cathode), the one or more separators, and the electrolyte. Each electrode tab may be electrically coupled with a positive battery terminal tab or a negative battery terminal tab, which may extend outside of the housing interior and are configured to be coupled to a load (e.g., an electric device powered by the battery).

In certain types of batteries, each anode may be larger than each cathode. For example, while the anode and the cathode may otherwise include the same or similar shape, the anode may be larger than the cathode. Further, the anode and the cathode may be stacked (e.g., with a separator therebetween) such that a perimeter of the anode is disposed outward from a perimeter of the cathode. In this way, the perimeter of the anode may substantially surround or encircle the perimeter of the cathode. Put differently, the anode may overhang the cathode along the perimeter of the cathode. This feature may be referred to by the present disclosure as an anode/cathode overhang and may contribute to safe operation of the battery. Indeed, a sufficient size of the anode/cathode overhang may be needed to ensure regulatory compliance and/or safe operation of the battery.

Due at least in part to manufacturing limitations in traditional embodiments, an actual size of an electrode in a traditional battery may substantially deviate from a nominal or design size of the electrode. Accordingly, in traditional batteries, the nominal or design size of the anode is relatively large compared to the nominal or design size of the cathode, thereby ensuring that, even if the actual sizes of the electrodes substantially deviate from the nominal or design sizes, the traditional battery will still include a sufficiently sized anode/cathode overhang. However, this may come at the cost of volumetric energy density of the battery. Indeed, while including a relatively large size disparity between the anode and the cathode ensures that the anode/cathode overhang is sufficiently sized despite the manufacturing limitations and deviations in traditional embodiments described above, the relatively large size disparity between the anode and the cathode contributes to wasted space within the housing interior defined by the housing of the battery.

In accordance with the present disclosure, a fine blanking technique is employed to produce anodes and cathodes such that deviations from the nominal or design sizes of the anode and the cathode are reduced. By reducing deviations from the nominal or design sizes of the anode and the cathode, a size of the cathode can be more closely aligned with a size of the anode while still ensuring a sufficient size of the anode/cathode overhang. In general, the fine blanking technique may include a single cutting step in which one or more electrodes is cut from a layered material, which may differ from traditional embodiments in which multiple cutting steps are employed, thus reducing manufacturing complexity, time, and cost. These and other features of the fine blanking technique contribute to more precise electrode sizes, namely, by reducing deviations from the nominal or design sizes. By reducing deviations from the nominal or design sizes, a size of the cathode may be increased relative to a size of the anode, while still ensuring a sufficient size of the anode/cathode overhang.

Another aspect of the present disclosure includes a growth of the size of the anode relative to the size of the housing. Indeed, in traditional embodiments, the size of the anode may be constrained by the above-described deviations from nominal or design size and a need to fit the anode within boundaries of the housing of the battery. By employing the fine blanking technique referenced above, the size of the anode and the size of the cathode may be increased (and the size of the cathode may be more closely aligned with the size of the anode) while ensuring a sufficiently sized anode/cathode overhang, and without substantially contributing to a footprint of the battery. Accordingly, a volumetric energy density of the present disclosed battery is improved over traditional embodiments. For example, the presently disclosed battery may include an approximately 1% increase in volumetric energy density. These and other features are described in detail below.

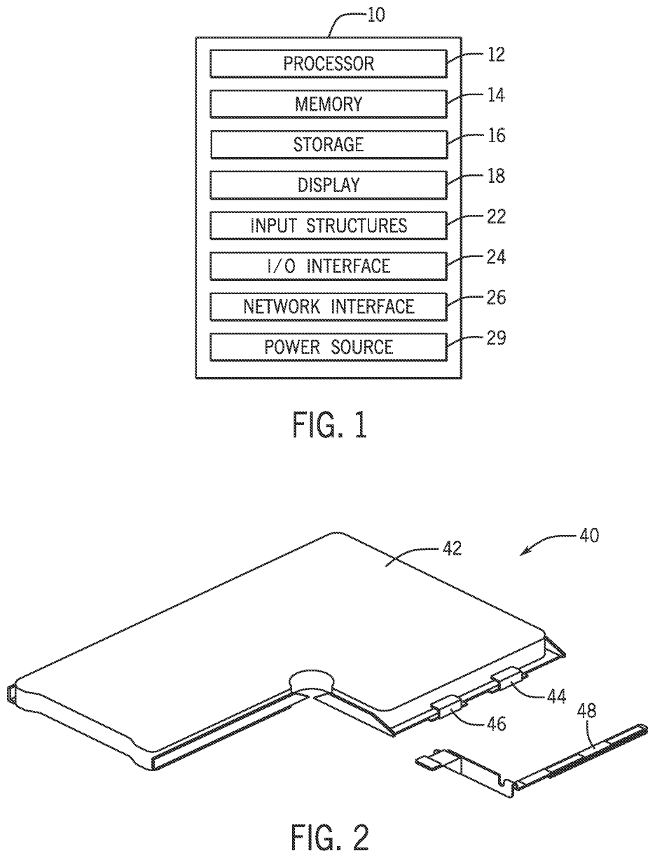

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/0) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth). The power source 29 of the electronic device 10 may include any suitable source of power, such as a rechargeable lithium polymer (Li-poly) battery and/or an alternating current (AC) power converter.

In accordance with the present disclosure, and as described in detail below with reference to later drawings, a battery (e.g., corresponding to the power source 29) of the electronic device 10 may include a housing, at least one anode disposed in the housing, and at least one cathode disposed in the housing, among other features. The anodes and/or the cathodes may be produced via a fine blanking technique in which actual sizes of the anodes and/or the cathodes are more closely aligned with nominal or design sizes of the anodes and/or the cathodes. That is, the fine blanking technique may reduce error margins in production of the anodes and/or the cathodes. As will be appreciated in view of the description below, more precise and/or consistent sizes of the anodes and/or the cathodes enable improved volumetric energy density of the battery relative to traditional embodiments.

FIG. 2 is an exploded perspective view of an embodiment of a battery 40 employed to power the electronic device 10 of FIG. 1. That is, the battery 40 may correspond to, or be included in, the power source 29 of the electronic device 10 of FIG. 1. In the illustrated embodiment, the battery 40 includes a housing 42, a positive battery terminal tab 44 extending outside of the housing 42, a negative battery terminal tab 46 extending outside of the housing 42, and a battery management unit (BMU) 48 configured to be disposed adjacent the positive battery terminal tab 44 and the negative battery terminal tab 46. Other componentry outside of the housing 42 of the battery 40 is also possible, such as adhesive layers configured to retain the BMU 48 at the top of the housing 42, sealing features configured to seal the housing 42 and prevent electrolyte leakage, and other features.

Electrodes (e.g., one or more anodes and one or more cathodes), one or more separators, and electrolyte of the battery 40 may be disposed in a housing interior defined by the housing 42. In certain embodiments, the electrodes and the one or more separators may be arranged via a stacking (e.g., zig-zag stacking) procedure before they are disposed in the housing interior defined by the housing 42. The electrodes, described in detail below with reference to later drawings, may be produced, extracted, created, or cut from a layered material via a fine blanking technique. The layered material of the anode may include, for example, a copper layer disposed between a first layer of graphite and a second layer of graphite. The layered material of the cathode may include, for example, an aluminum layer disposed between a first layer of lithium cobalt oxide and a second layer of lithium cobalt oxide. Other layered materials are also contemplated.

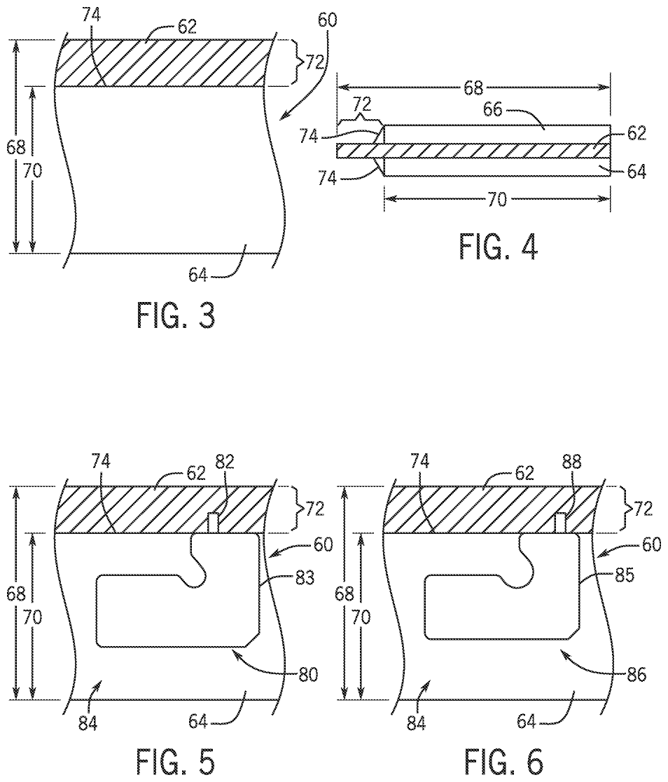

FIG. 3 is an overhead view of an embodiment of a layered material 60 employed to produce one or more battery electrodes for the battery 40 of FIG. 2. The layered material 60 includes an inner layer 62, a first outer layer 64, and a second outer layer (not shown), where the inner layer 62 is disposed between the first outer layer 64 and the second outer layer (not shown). FIG. 4 is a side cross-sectional view of an embodiment of the layered material 60 of FIG. 3 in which a second outer layer 66 is shown. The inner layer 62 in FIG. 4 is positioned between the first outer layer 64 and the second outer layer 66. As previously described, for an anode, the inner layer 62 may include copper, whereas the first outer layer 64 and the second outer layer 66 may include graphite. For a cathode, the inner layer 62 may include aluminum, whereas the first outer layer 64 and the second outer layer 66 may include lithium cobalt oxide. Other compositions of the layered material 60 are also possible. As will be described in detail below, the inner layer 62 may include a height 68 that is larger than a height 70 of each of the first and second outer layers 64, 66. An exposed portion 72 of the inner layer 62 extending above tops 74 of the first and second outer layers 64, 66 may form at least a part of an electrode tab extending from a body of the electrode.

FIG. 5 is an overhead view of an embodiment of the layered material 60 of FIGS. 3 and 4, in which an anode 80 is cut from the layered material 60 via a fine blanking technique. In the illustrated embodiment, the inner layer 62 of the layered material 60 may include copper, and the first outer layer 64 and the second outer layer (not shown) may include graphite. As shown, the anode 80 is cut from the layered material 60 such that an electrode tab 82 (or anode tab) is formed at least in part by the exposed portion 72 of the inner layer 62. In some embodiments, a portion of the electrode tab 82 is formed by the exposed portion 72 of the inner layer 62 and an additional portion of the electrode tab 82 is formed by a combination of the inner layer 62, the first outer layer 64, and the second outer layer 66 illustrated in FIG. 4. In other words, in some embodiments, the anode 80 may be cut in a lower position of the layered material 60 than is illustrated in FIG. 5, such that the electrode tab 82 includes a first portion formed by a combination of the first outer layer 64, the inner layer 62, and the second outer layer (not shown), and a second portion formed by the exposed portion 72 of the inner layer 62. As illustrated in FIG. 5, the portion of the layered material 60 that does not form a part of the anode 80 may be referred to as stock material 84.

FIG. 6 is an overhead view of an embodiment of the layered material 60 of FIGS. 3 and 4, in which a cathode 86 is cut from the layered material via a fine blanking process. In the illustrated embodiment, the inner layer 62 of the layered material 60 may include aluminum, and the first outer layer 64 and the second outer layer (not shown) may include lithium cobalt oxide. As shown, the cathode 86 is cut from the layered material 60 such that an electrode tab 88 (or cathode tab) is formed by the exposed portion 72 of the inner layer 62. In some embodiments, a portion of the electrode tab 88 is formed by the exposed portion 72 of the inner layer 62 and an additional portion of the electrode tab 82 is formed by a combination of the inner layer 62, the first outer layer 64, and the second outer layer 66 illustrated in FIG. 4. In other words, in some embodiments, the cathode 86 may be cut in a lower position of the layered material 60 than is illustrated in FIG. 6, such that the electrode tab 88 includes a first portion formed by a combination of the first outer layer 64, the inner layer 62, and the second outer layer (not shown), and a second portion formed by the exposed portion 72 of the inner layer 62. As is the case with respect to FIG. the portion of the layered material 60 that does not form a part of the cathode 86 is denoted as the stock material 84.

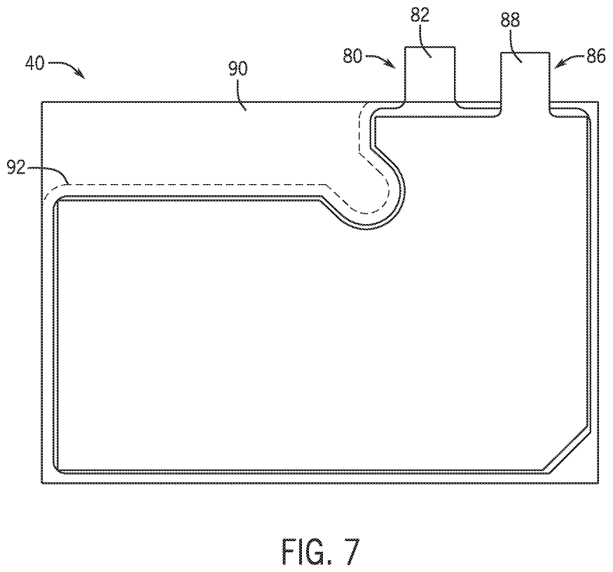

As previously described, and as can be seen with respect to FIGS. 5 and 6, the anode in FIG. 5 may be larger than the cathode 86 in FIG. 6, although the anode 80 and the cathode 86 may otherwise include the same or similar shape. In general, the anode 80 and the cathode 86 may be stacked, along with a separator therebetween, such that the shape of the anode 80 overhangs the cathode 86. An example of a separator is provided in FIG. 7, which includes a side cross-sectional view of an embodiment of a portion of the battery 40 of FIG. 2 including the anode 80 of FIG. 5, the cathode 86 of FIG. 6, and a separator 90. As shown, the separator 90 is disposed between the anode 80 and the cathode 86. That is, a first side of the separator 90 contacts (or faces) the anode 80 and a second side of the separator 90 contacts (or faces) the cathode 86. In some embodiments, the separator 90 may be cut along (or adjacent to) line 92, such that a shape of the separator 90 is similar to the shapes of the anode 80 and the cathode 86.

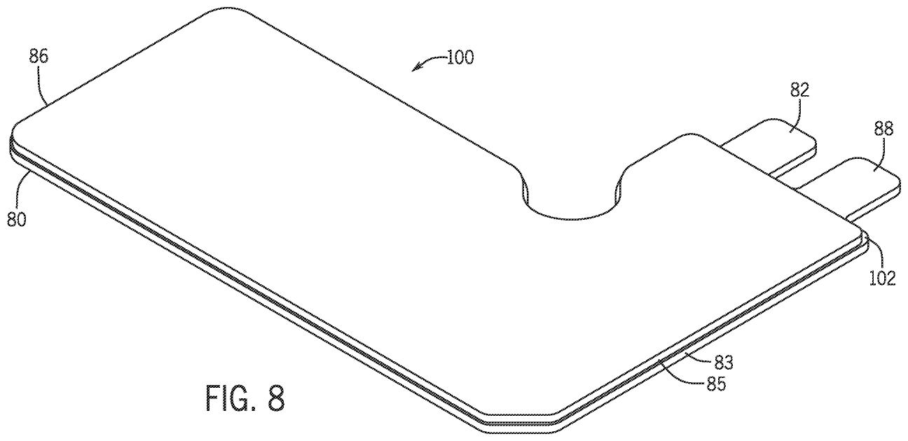

In some embodiments, multiple instances of the anode 80 and the cathode 86 may be stacked in an alternating order, and the separator 90 may zig-zag (e.g., be applied in an alternating and/or back-and-forth manner) between the various anodes 80 and cathodes 86 (or multiple instances of the separator 90 may be employed, each being disposed between adjacent instances of the anode 80 and the cathode 86). With reference again to FIGS. 5 and 6, when the anode(s) 80 and the cathode(s) 86 are stacked in a stacked arrangement, a perimeter 83 of the anode 80 (e.g., illustrated in FIG. 5) may substantially surround or encircle a perimeter 85 of the cathode 86 (e.g., illustrated in FIG. 6). The gap between the perimeter 83 of the anode 80 in FIG. 5 and the perimeter 85 of the cathode 86 in FIG. 6 may be referred to as an anode/cathode overhang, which is illustrated in FIG. 8 and described in detail below. While the anode/cathode overhang should be sufficiently sized to ensure proper and safe operation of the battery, a relatively large anode/cathode overhang may reduce a volumetric energy density of the battery, as previously described. In accordance with the present disclosure, and as outlined in detail below, the anode 80 and the cathode 86 may be produced via a fine blanking technique that ensures a sufficiently sized anode/cathode overhang while reducing a size disparity between the anode 80 and the cathode 86.

FIG. 8 is a perspective view of an embodiment of a stacked arrangement 100 including the anode 80 of FIG. 5, the cathode 86 of FIG. 6, and an anode/cathode overhang 102 defined by the stacked arrangement 100. In practice, a separator (not shown) may be disposed between the anode 80 and the cathode 86, but for purposes of clarity the separator is excluded in FIG. 8. As previously described, the anode 80 is larger than the cathode 86, although the anode 80 and the cathode 86 may otherwise include the same or similar shape. The anode 80 is positioned over and relative to the cathode 86 such that the anode/cathode overhang 102 substantially surrounds or encircles the perimeter 83 of the cathode 86. In other words, the perimeter 85 of the cathode 86 is disposed inwards from the perimeter 83 of the anode 80 in the stacked arrangement 100. In this way, the anode/cathode overhang 102 is defined between the perimeter 85 of the cathode 86 and the perimeter 83 of the anode 80.

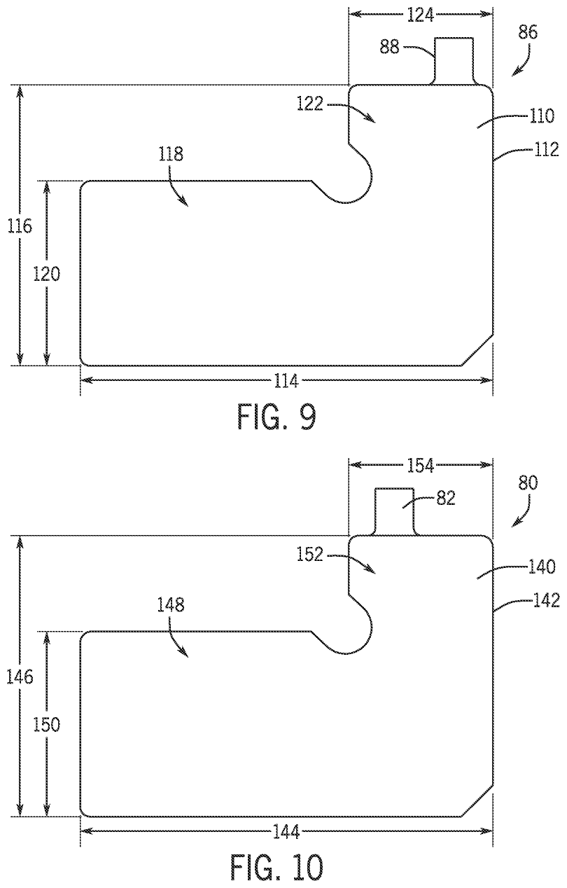

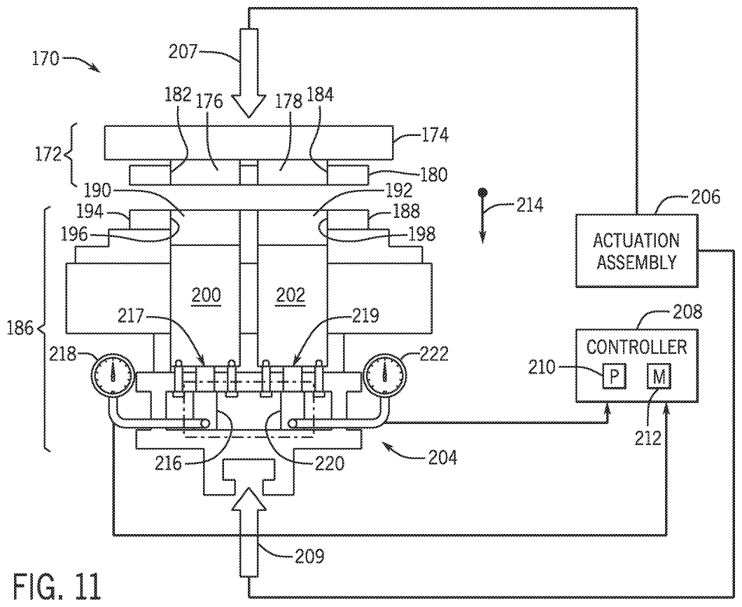

While the anode/cathode overhang 102 may need to be sufficiently sized in order to ensure proper and safe functionality of the corresponding battery, a relatively large size of the anode/cathode overhang 102 reduces a volumetric energy density of the corresponding battery. As previously described, traditional techniques for electrode production may include a nominal or design anode size that is relatively large compared to a nominal or design cathode size, which allows for relatively large deviations from the nominal or design sizes while still ensuring a sufficient anode/cathode overhang size. In accordance with the present disclosure, a fine blanking technique is employed to produce the cathode 86, the anode 80, and the anode/cathode overhang 102 illustrated in FIG. 8. Sizing features of the anode 80 and the cathode 86 are described in detail below with reference to FIGS. 9 and 10, followed by a description of the fine blanking technique with reference to FIGS. 11-15.

FIG. 9 is an overhead view of an embodiment of the cathode 86 employed in the battery of FIG. 2. FIG. 10 is an overhead view of an embodiment of the anode 80 employed in the battery 40 of FIG. 2. With reference to FIGS. 9 and 10, various dimensional data of the cathode 86 and the anode 80 is provided below. As previously described, fine blanking technique according to the present disclosure enables a size of the cathode 86 to more closely align with the size of the anode 80, while still maintaining a sufficiently sized anode/cathode overhang when the cathode 86 and the anode 80 are stacked (e.g., via a zig-zag stacking procedure).

In FIG. 9, the cathode 86 includes a cathode face 110 formed by a cathode body 112, where the cathode tab 88 extends from the cathode body 112. For purposes of the present disclosure and dimensional data set forth below, the cathode tab 88 is not considered a part of the cathode body 112 or the corresponding cathode face 110. The cathode body 112 includes a width 114 (e.g., a maximum width) along the cathode face 110 and a height 116 (e.g., maximum height) along the cathode face 110. The width 114 may be within a range, for example, of approximately 74.78 millimeters and 74.94 millimeters. The height 116 may be within a range, for example, of approximately 49.9 millimeters and 50.06 millimeters. A lower portion 118 of the cathode body 112 includes an additional height 120 along the cathode face 110. The additional height 120 may be within a range, for example, of approximately 32.9 millimeters and 33.06 millimeters. An upper portion 122 of the cathode body 112 includes an additional width 124 along the cathode face 110. The additional width 124 may be within a range, for example, of approximately 25.43 millimeters and 25.59 millimeters.

In FIG. 10, the anode 80 includes an anode face 140 formed by an anode body 142, where the anode tab 82 extends from the anode body 142. For purposes of the present disclosure and dimensional data set forth below, the anode tab 82 is not considered a part of the anode body 142 or corresponding anode face 140. The anode body 142 includes a width 144 (e.g., maximum width) along the anode face 140 and a height 146 (e.g., maximum height) along the anode face 140. The width 144 may be within a range, for example, of approximately 75.38 millimeters and millimeters. The height 146 may be within a range, for example, of approximately 51.07 millimeters and 51.23 millimeters. A lower portion 148 of the anode body 142 includes an additional height 150 along the anode face 140. The additional height 150 may be within a range, for example, of approximately 33.5 millimeters and 33.64 millimeters. An upper portion 152 of the anode body 142 includes an additional width 154 along the anode face 140. The additional width 154 may be within a range, for example, of approximately 26.03 millimeters and 26.19 millimeters. As previously described, the anode 80 is generally larger than the cathode 86 to ensure a sufficiently sized anode/cathode overhang that enables proper and safe functionality of the corresponding battery. However, due to presently disclosed fine blanking techniques that reduce deviations in actual electrode size from nominal or design electrode size, as previously described, the size of the cathode 86 can be more closely aligned with the size of the anode 80 while ensuring a sufficiently sized anode/cathode overhang.

For example, a width ratio (e.g., maximum width ratio) between the width 144 in FIG. 10 and the width 114 in FIG. 9 may be approximately 1.0077. In other words, the width ratio may be between 1.006 and 1.009, between 1.0065 and 1.0085, or between 1.007 and 1.008. Further, a height ratio (e.g., maximum height ratio) between the height 146 in FIG. 10 and the height 116 in FIG. 9 may be approximately 1.0234. In other words, the height ratio may be between 1.022 and 1.024. Further, an additional width ratio between the width 154 (e.g., corresponding to the upper portion 152 in FIG. 10) and the width 124 (e.g., corresponding to the upper portion 122 FIG. 9) may be approximately 1.0235. In other words, the additional width ratio (e.g., corresponding to the upper portions 152, 122 of the anode 80 and the cathode 86, respectively) may be between 1.020 and 1.027, between 1.021 and 1.026, or between 1.022 and 1.025, or between 1.023 and 1.024. Further still, an additional height ratio between the height 150 (e.g., corresponding to the lower portion 148 in FIG. 10) and the height 120 (e.g., corresponding to the lower portion 118 in FIG. 9) may be approximately 1.0182. In other words, the additional height ratio (e.g., corresponding to the lower portions 148, 118 of the anode 80 and the cathode 86, respectively) may be between 1.015 and 1.020, between 1.016 and 1.019, or between 1.017 and 1.0185. In general, the various ratios (e.g., width ratios and height ratios) described in detail above may be smaller (e.g., closer to 1) than in traditional embodiments, while still ensuring a sufficiently sized anode/cathode overhang to enable proper functioning of the corresponding battery.

Due at least in part to the above-described features, a surface area of the cathode face 110 in FIG. 9 may be more closely aligned with a surface area of the anode face 140 in FIG. 10 (e.g., relative to traditional embodiments). For example, a surface area ratio between the surface area of the anode face 140 and the surface area of the cathode face 110 may be approximately 1.0339. In other words, the surface area ratio may be between 1.030 and 1.038, between 1.031 and 1.037, between 1.032 and 1.036, or between 1.033 and 1.035. In an embodiment, the surface area of the anode face 140 may be within a range, for example, of approximately 2920 and 2940 millimeters squared. Further, in an embodiment, the surface area of the cathode face 110 may be within a range, for example, of approximately 2820 and 2840 millimeters squared. The surface area ratio between the surface area of the anode face 140 and the surface area of the cathode face 110 may be substantially smaller (e.g., closer to 1) than in tradition embodiments, while still ensuring a sufficiently sized anode/cathode overhang. Indeed, in general, the width ratios, the height ratios, and the surface area ratio, in accordance with the present disclosure and described above, may be substantially smaller (e.g., closer to 1) than in traditional embodiments while still ensuring a sufficient anode/cathode overhang. Accordingly, a volumetric energy density of the corresponding battery is improved relative to traditional embodiments, at least because the battery of the present disclosure reduces wasted space attributable to size differences between the electrodes.

FIGS. 11-15 illustrate various fine blanking techniques that produce electrodes in accordance with the present disclosure. As previously described, the presently disclosed fine blanking techniques enable the electrodes to be produced, extracted, created, or cut with more size consistency and/or precision, reducing deviations of actual sizes of the electrodes from nominal or design sizes of the electrodes. In doing so, a sufficiently sized anode/cathode overhang is provided without sizing the cathode unnecessarily large, thereby improving volumetric energy density of batteries compared to traditional embodiments.

FIG. 11 is a schematic side view of an embodiment of a fine blanking system 170 that produces or creates electrodes for the battery 40 of FIG. 2. In the illustrated embodiment, the fine blanking system 170 includes an upper portion 172 having an upper shoe 174, a first punch 176, a second punch 178, and a stripper 180 defining a first stripper opening 182 through which the first punch 176 extends and a second stripper opening 184 through which the second punch 178 extends. The fine blanking system 170 also includes a lower portion 186 having a lower shoe 188, a first suction pad 190 (or plate) corresponding to the first punch 176, a second suction pad 192 (or plate) corresponding to the second punch 178, and a die 194 defining a first die opening 196 through which the first suction pad 190 extends and a second die opening 198 through which the second suction pad 192 extends. The lower portion 186 may also include a first connector 200 coupled to (or forming a part of) the first suction pad 190 and a second connector 202 coupled to (or forming a part of) the second suction pad 192. The lower portion 186 may also include a spring assembly 204 coupled to the first connector 200 and the second connector 202.

An actuation assembly 206 (e.g., including one or more servomotors) of the fine blanking system 170 may be employed to exert a force 207 against the upper portion 172, namely, the upper shoe 174 of the upper portion 172 and/or the lower portion 186 of the fine blanking system 170. The actuation assembly 206 may additionally or alternatively exert a force 209 against the lower portion 186 of the fine blanking system 170. In some embodiments, the force 209 may be exerted against the lower portion 186 of the fine blanking system 170 via a platform, surface, or mount on which the fine blanking system 170 is disposed. In other embodiments, one motor (e.g., servomotor) of the actuation assembly 206 may exert the force 207 against the upper shoe 174 of the upper portion 172 of the fine blanking system 170, and another motor (e.g., servomotor) of the actuation assembly 206 may exert the force 209 against the lower portion 186 of the fine blanking system 170. Other actuation mechanisms employing the actuation assembly 206 are also contemplated by the present disclosure.

A controller 208 of the fine blanking system 170 may include processing circuitry 210 and memory circuitry 212 storing instructions thereon that, when executed by the processing circuitry 210, cause the controller 208 to perform various functions. The processing circuitry 210 and/or the memory circuitry 212 may be similar to that of the processor 12 and/or the memory 14 described with reference to FIG. 1, respectively. In particular, the controller 208 may control the actuation assembly 206 based on data feedback associated with the spring assembly 204. The force 207 exerted by the actuation assembly 206 against the upper shoe 174, for example, may cause the upper shoe 174, the first punch 176, and the second punch 178 to move in a downwards direction 214 relative to the stripper 180 of the upper portion 172 of the fine blanking system 170. Thus, the first punch 176 and the second punch 178 may move, in the downwards direction 214, toward the first suction pad 190 and the second suction pad 192. A layered material (e.g., the layered material 60 in FIGS. 3 and 4) may be disposed across the lower portion 186 of the fine blanking system 170, for example, across the die 194 and/or the suction pads 190, 192.

The first punch 176 and the first suction pad 190 may sandwich (e.g., squeeze or hold in place) a first portion of the layered material therebetween, and the second punch 178 and the second suction pad 192 may sandwich a second portion of the layered material therebetween. The force 207 from the actuation assembly 206, controlled by the controller 208, may continue to press the upper shoe 174, the first punch 176, and the second punch 178 in the downwards direction 214. The first suction pad 190 and the second suction pad 192 may also be forced in the downwards direction 214 (e.g., via the first punch 176 and the second punch 178, respectively) and relative to the die 194. In this way, the first punch 176 may be forced into the first die opening 196, and the second punch 178 may be forced into the second die opening 198.

As the first punch 176, the second punch 178, the first suction pad 190, and the second suction pad 192 continue to be forced in the downwards direction 214 (e.g., through the first and second die openings 196, 198), a first electrode may be cut from the layered material (e.g., corresponding to the first die opening 196), and a second electrode may be cut from the layered material (e.g., corresponding to the second die opening 198). That is, the first electrode may take the shape of the first opening 196 formed in the die, and the second electrode may take the shape of the second opening 198 in the die 194. It should be noted that the first electrode and the second electrode may both correspond to anodes, the first electrode and the second electrode may both correspond to cathodes, or the first electrode may correspond to an anode and the second electrode may correspond to a cathode.

As described above, the controller 208 may control the force 207 exerted by the actuation assembly 206 on the upper shoe 174 and, in some embodiments, the force 209 exerted on the lower portion 186 of the fine blanking system 170. In some embodiments, the controller 208 may control aspects of the fine blanking system 170 based on data feedback received from the spring assembly 204. For example, in the illustrated embodiment, the spring assembly 204 includes a first gas spring 216 coupled to the first connector 200 via a first extension 217, a first pressure sensor 218 corresponding to the first gas spring 216 (e.g., configured to detect a pressure in the first gas spring 216), a second gas spring 220 coupled to the second connector 202 via a second extension 219, and a second pressure sensor 222 corresponding to the second gas spring 220 (e.g., configured to detect a pressure in the second gas spring 220). The first gas spring 216 and the second gas spring 220 may be, for example, nitro gas springs. As the suction pads 190, 192 are forced in the downward direction 214 as described above, the connectors 200, 202 extending from the suction pads 190, 192 may exert respective forces on the gas springs 216, 220 (e.g., via the extensions 217, 219). Accordingly, a first pressure in the first gas spring 216 and a second pressure in the second gas spring 220 may increase during the cutting process.

The controller 208 may receive data feedback from the first pressure sensor 218 and the second pressure sensor 222 and control the actuation assembly 206 based on the data feedback. As an example, due to ambient conditions, wear on certain parts of the fine blanking system 170, and/or other conditions, a correspondence between the spring pressure (e.g., in the first gas spring 216 and/or the second gas spring 220) and the force(s) 207 and/or 209 may change over time. Indeed, the controller 208 may determine, based on the data feedback from the pressure sensors 218, 222, that an increase or reduction in the force(s) 207 and/or 209 to properly cut the electrode from the layered material is needed. Accordingly, the controller 208 may periodically adjust the force(s) 207 and/or 209 in response to the data feedback from the pressure sensors 218, 222. Additionally or alternatively, the controller 208 may control an aspect of the first gas spring 216, the second gas spring 220, or both to increase or reduce spring forces within the first and/or second gas springs 216, 220. Based on the above-described controls, the fine blanking system 170 may precisely cut the first and second electrodes from the layered material while reducing or negating burring and/or cracking in the electrodes, among other technical benefits. Other aspects of the fine blanking system 170, described in detail below, may also contribute to reducing or negating burring and/or cracking in the electrodes.

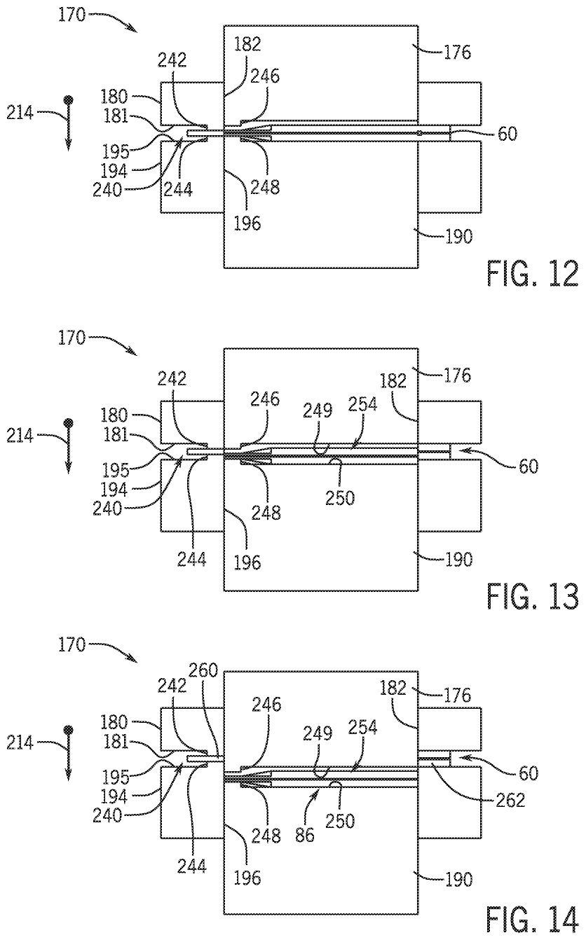

FIGS. 12-14 illustrate various steps of a fine blanking process in which one or more electrodes are cut from a layered material of the fine blanking system 170. For example, FIG. 12 is a schematic side view of an embodiment of a portion of the fine blanking system 170 of FIG. 11 in which the punch 176 is disengaged from the layered material 60. As shown, the layered material 60 may be disposed between the punch 176 and the suction pad 190. That is, the layered material 60 may be disposed across the suction pad 190 and/or the die 194 while the punch 176 is disposed above the layered material 60. Further, the layered material 60 may include an end piece 240 that is positioned between an extension 242 of the stripper 180 (e.g., extending from, and transverse to, a surface 181 of the stripper 180) and an extension 244 of the die 194 (e.g., extending from, and transverse to, a surface 195 of the die 194). The extensions 242, 244 may be employed to improve a cutting precision and/or reduce burring/cracking as the electrode is cut from the layered material 60. An extension 246 of the punch 176 and an extension 248 of the suction pad 190, described in detail below, may also contribute to a reduction of burring and/or cracking as the electrode is cut from the layered material 60.

FIG. 13 is a schematic side view of an embodiment of a portion of the fine blanking system 170 of FIG. 11 in which the punch 176 is engaged with the layered material 60 and in the process of coordinating with the suction pad 190 to cut an electrode from the layered material 60. As shown in the illustrated embodiment, the punch 176 is forced downwardly until the end piece 240 of the layered material 60 is sandwiched between the extension 246 of the punch 176 and the extension 248 of the suction pad 190. In this way, the end piece 240 of the layered material 60 is sandwiched between the extension 242 of the stripper 180 and the extension 244 of the die 194, and the end piece 240 of the layered material 60 is sandwiched between the extension 246 of the punch 176 and the extension 248 of the suction pad 190. A body 254 of the layered material 60 may also be sandwiched between a surface 249 of the punch 176 and a surface 250 of the suction pad 190. Because the body 254 of the layered material 60 is wider than the end piece 240 of the layered material, a gap between the surface 249 and the surface 250 may be larger than a gap between the extension 246 of the punch 176 and the extension 248 of the suction pad 190. As described above, these and other features reduce burring and/or cracking of the electrode being cut from the layered material 60.

FIG. 14 is a schematic side view of an embodiment of a portion of the fine blanking system 170 of FIG. 11 in which an electrode (e.g., the cathode 86 of FIG. 6) is cut from the layered material 60. While FIG. 14 is described below with respect to the cathode 86 of FIG. 6, it should be understood that the same or similar features can be employed with respect to the anode 80 of FIG. 5.

As shown, the punch 176 is forced in the downwards direction 214 into the die opening 196. The cathode 86 is cut from the layered material 60 as the punch 176 is forced in the downwards direction 214. Indeed, a portion 260 of the end piece 240 of the layered material 60 and an additional portion 266 of the layered material 60 is removed such that the cathode 86 is formed from the layered material 60. The portion 260 of the end piece 240 of the layered material 60 and the additional portion 266 of the layered material 60 may be referred to as stock material or waste material. After the cathode 86 is cut from the layered material 60, the punch 176 and the suction pad 190 may be returned to the positions illustrated in FIG. 12, such that the cathode 86 can be removed from the assembly.

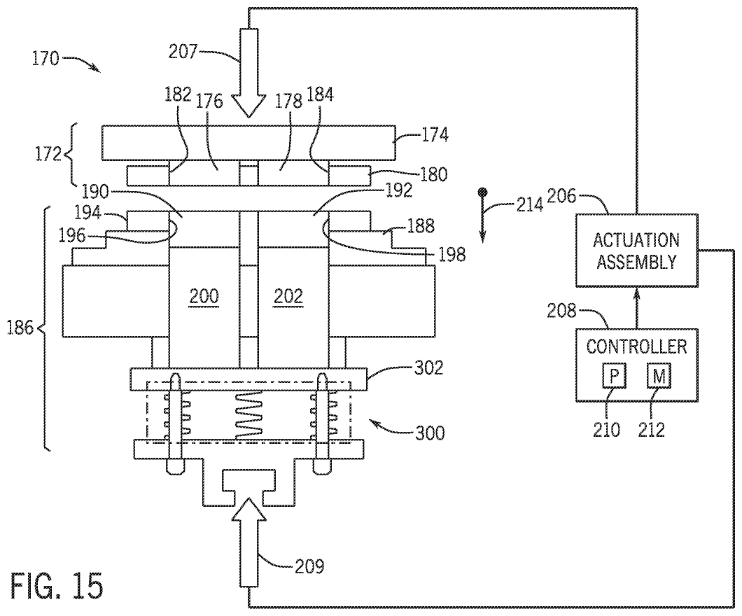

It should be noted that other fine blanking system and techniques are also possible. For example, FIG. 15 is a schematic side view of another embodiment of the fine blanking system 170 in which the spring assembly 204 is omitted. For example, the embodiment of the fine blanking system 170 in FIG. 15 includes the same or similar features as the embodiment of the fine blanking system 170 in FIG. 11, except that the fine blanking system 170 in FIG. 15 does not include the first gas spring 216 in FIG. 11, does not include the first pressure sensor 218 in FIG. 11, does not include the second gas spring 220 in FIG. 11, does not include the second pressure sensor 222 in FIG. 11, and does not include the data feedback associated with the first and second pressure sensors 218, 222 in FIG. 11. Instead, the fine blanking system 170 in FIG. 15 employs a mechanical (or coil) spring assembly 300 coupled to a single plate 302, where the single plate 302 is coupled to both the first connector 200 (corresponding to the first suction pad 190) and the second connector 202 (corresponding to the second suction pad 192).

In general, embodiments of the present disclosure are directed toward batteries including electrodes generated via fine blanking techniques. Presently disclosed fine blanking techniques reduce deviations of actual sizes of battery electrodes from nominal sizes of battery electrodes. In doing so, a sufficiently sized anode/cathode overhang is provided without an unnecessarily large size different between the anode and the cathode. These and other features contribute to an improved volumetric energy density relative to traditional embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

1. A battery, comprising:
a separator having a first side and a second side opposing the first side;
an anode having an anode face that faces the first side of the separator, wherein the anode face comprises an anode face surface area; and
a cathode having a cathode face that faces the second side of the separator, wherein the cathode face comprises a cathode face surface area, and wherein a surface area ratio between the anode face surface area and the cathode face surface area is between 1.030 and 1.038.

2. The battery of claim 1, wherein the surface area ratio between the anode face surface area and the cathode face surface area is between 1.033 and 1.035.

3. The battery of claim 1, wherein the anode comprises a layered material having:
a first layer comprising graphite;
a second layer comprising graphite; and
a third layer comprising copper and disposed between the first layer and the second layer.

4. The battery of claim 1, wherein the cathode comprises a layered material having:
a first layer comprising lithium cobalt oxide;
a second layer comprising lithium cobalt oxide; and
a third layer comprising aluminum and disposed between the first layer and the second layer.

5. The battery of claim 1, wherein:
the anode comprises an anode tab extending from the anode face; and
the cathode comprises a cathode tab extending from the cathode face.

6. The battery of claim 1, wherein:
the anode face comprises an anode width dimension;
the cathode face comprises a cathode width dimension; and
a width ratio between the anode width dimension and the cathode width dimension is between 1.006 and 1.009.

7. The battery of claim 1, wherein:
the anode face comprises an anode height dimension;
the cathode face comprises a cathode height dimension; and
a height ratio between the anode height dimension and the cathode height dimension is between 1.022 and 1.024.

8. The battery of claim 1, comprising:
a plurality of anodes including the anode;
a plurality of cathodes including the cathode; and
a plurality of separators including the separator, wherein the plurality of anodes, the plurality of cathodes, and the plurality of separators are arranged in a stacked configuration.

9. The battery of claim 1, wherein the anode face and the cathode face are aligned such that an anode/cathode overhang is defined between an anode perimeter of the anode face and a cathode perimeter of the cathode face.

10. A battery, comprising:
an anode having an anode face comprising an anode width dimension and an anode height dimension;
a cathode having a cathode face comprising a cathode width dimension and a cathode height dimension;
a width ratio between the anode width dimension and the cathode width dimension within a first range of 1.006 to 1.009; and
a height ratio between the anode height dimension and the cathode height dimension within a second range of 1.022 to 1.024.

11. The battery of claim 10, wherein:
the anode face comprises an anode face surface area;
the cathode face comprises a cathode face surface area; and
a surface area ratio between the anode face surface area and the cathode face surface area is within a third range of 1.030 to 1.038.

12. The battery of claim 10, wherein:
the anode comprises an anode tab extending from the anode face; and
The cathode comprises a cathode tab extending from the cathode face.

13. The battery of claim 10, comprising a separator configured to be disposed between the anode and the cathode, wherein:
the separator comprises a first side and a second side opposing the first side;
the anode face is configured to face the first side of the separator; and
the cathode face is configured to face the second side of the separator.

14. The battery of claim 10, wherein the anode face and the cathode face are aligned such that an anode/cathode overhang is defined between an anode perimeter of the anode face and a cathode perimeter of the cathode face.

15. The battery of claim 10, wherein the anode comprises a layered material having:
a first layer comprising graphite;
a second layer comprising graphite; and
a third layer comprising copper and disposed between the first layer and the second layer.

16. The battery of claim 10, wherein the cathode comprises a layered material having:
a first layer comprising lithium cobalt oxide;
a second layer comprising lithium cobalt oxide; and
a third layer comprising aluminum and disposed between the first layer and the second layer.

17. A battery assembly, comprising:
an anode having an anode face, wherein the anode face comprises an anode face surface area;
a cathode having a cathode face, wherein the cathode face comprises a cathode face surface area, and wherein a surface area ratio between the anode face surface area and the cathode face surface area is between 1.030 and 1.038; and
a portion of the anode forming an anode/cathode overhang that extends beyond a perimeter of the cathode.

18. The battery assembly of claim 17, comprising a separator having a first side and a second side, wherein the anode is disposed on the first side of the separator and the cathode is disposed on the second side of the separator.

19. The battery assembly of claim 18, wherein the anode face faces the first side of the separator.

20. The battery assembly of claim 18, wherein the cathode face faces the second side of the separator.
